(19) United States
(12) Patent Application Publication
(10) Pub. No.: US 2013/0146580 A1
(43) Pub. Date: Jun. 13, 2013

(54) HEATER UNIT, FIRING FURNACE, AND METHOD OF MANUFACTURING SILICON-CONTAINING POROUS CERAMIC FIRED BODY

(71) Applicant: Ibiden Co., Ltd., Ogaki-shi (JP)

(72) Inventors: Takamitsu SAIJO, Ibi-gun (JP); Tadafumi OHASHI, Ibi-gun (JP)

(73) Assignee: IBIDEN CO., LTD., Ogaki-shi (JP)

(21) Appl. No.: 13/693,072

(22) Filed: Dec. 4, 2012

(30) Foreign Application Priority Data
Dec. 12, 2011 (JP) PCT/JP2011/078693

(51) Int. Cl. F27B 5/14; F27B 9/36; H05B 1/02

(52) U.S. Cl. CPC F27B 5/14; H05B 1/0202; H05B 1/0225; F27B 9/36
USPC 219/388; 219/482; 219/488; 219/492; 219/390

(57) ABSTRACT

A heater unit includes a power source, a plurality of heaters, and a power supply position-switching device. The power source includes a first power source terminal and a second power source terminal. The plurality of heaters are each connected to one another in series and include a first heater and a second heater. The power supply position-switching device is configured to switch between a first state and a second state. In the first state, the first power source terminal is connected with a first heater terminal of the first heater, and the second power source terminal is connected with a third heater terminal of the second heater. In the second state, the first power source terminal is connected with a second heater terminal of the first heater, and the second power source terminal is connected with a fourth heater terminal of the second heater.

### CROSS-REFERENCE TO RELATED APPLICATIONS

The present application claims priority under 35 U.S.C. §119 to PCT/JP2011/078693 filed on Dec. 12, 2011, the contents of which are incorporated herein by reference in their entirety.

### BACKGROUND OF THE INVENTION

1. Field of the Invention

The present invention relates to a heater unit, a firing furnace, and a method of manufacturing a silicon-containing porous ceramic fired body.

2. Discussion of the Background

These days, particulates such as soot contained in exhaust gases discharged from internal combustion engines of vehicles (e.g. buses, trucks) and construction machines have raised problems as contaminants harmful to the environment and the human body. Then, various honeycomb structured bodies made of porous ceramics have been proposed as a particulate filter for purifying exhaust gases by capturing particulates in exhaust gases.

As such honeycomb structured bodies, those each including a plurality of rectangular pillar-shaped honeycomb fired bodies bonded with one another with adhesive layers interposed therebetween have been used. The honeycomb fired bodies are manufactured by performing treatments such as extrusion molding, degreasing, and firing on a mixture containing ceramic materials such as silicon carbide.

Generally, honeycomb fired bodies are manufactured by firing, in a firing furnace, honeycomb molded bodies prepared by molding ceramic materials. WO 2006/013932 A1 discloses an example of the firing furnace.

In the firing furnace disclosed in WO 2006/013932 A1, a plurality of heaters for heating subjects are connected in series with a power source. Moreover, each of the heaters includes a plurality of resistance heating elements connected in parallel with the power source.

The content of WO 2006/013932 A1 is incorporated herein by reference in their entirety.

### SUMMARY OF THE INVENTION

According to one aspect of the present invention, a heater unit includes a power source, a plurality of heaters, and a power supply position-switching device. The power source includes a first power source terminal and a second power source terminal. The plurality of heaters are each connected to one another in series with respect to the power source. The plurality of heaters includes a first heater and a second heater. The first heater is connected to the first power source terminal and has a first heater terminal and a second heater terminal. The second heater is connected to the second power source terminal and has a third heater terminal and a fourth heater terminal. The power supply position-switching device is configured to switch between a first state and a second state. In the first state, the first power source terminal is connected with the first heater terminal of the first heater, the second power source terminal is connected with the third heater terminal of the second heater, and the second heater terminal of the first heater is directly or indirectly connected with the fourth heater terminal of the second heater. In the second state, the first power source terminal is connected with the second heater terminal of the first heater, the second power source terminal is connected with the fourth heater terminal of the second heater, and the first heater terminal of the first heater is directly or indirectly connected with the third heater terminal of the second heater.

According to another aspect of the present invention, a firing furnace includes a power source, a casing, a firing chamber, a plurality of heaters, and a power supply position-switching device. The power source includes a first power source terminal and a second power source terminal. The firing chamber is disposed in the casing. The plurality of heaters are disposed in the casing and each connected to one another in series with respect to the power source. The plurality of heaters include a first heater and a second heater. The first heater is connected to the first power source terminal and has a first heater terminal and a second heater terminal. The second heater is connected to the second power source terminal and has a third heater terminal and a fourth heater terminal. The power supply position-switching device is configured to switch between a first state and a second state. In the first state, the first power source terminal is connected with the first heater terminal of the first heater, the second power source terminal is connected with the third heater terminal of the second heater, and the second heater terminal of the first heater is directly or indirectly connected with the fourth heater terminal of the second heater. In the second state, the first power source terminal is connected with the second heater terminal of the first heater, the second power source terminal is connected with the fourth heater terminal of the second heater, and the first heater terminal of the first heater is directly or indirectly connected with the third heater terminal of the second heater.

According to further aspect of the present invention, a method of manufacturing a silicon-containing porous ceramic fired body, includes preparing a subject to be fired from a composition containing silicon-containing ceramic powders. The subject is fired using a firing furnace. The firing furnace includes a power source, a casing, a firing chamber, a power supply position-switching device, and a plurality of heaters. The power source includes a first power source terminal and a second power source terminal. The firing chamber is disposed in the casing. The plurality of heaters are disposed in the casing and each connected to one another in series with respect to the power source. The plurality of heaters include a first heater and a second heater. The first heater is connected to the first power source terminal and has a first heater terminal and a second heater terminal. The second heater is connected to the second power source terminal and has a third heater terminal and a fourth heater terminal. A state of the furnace is switched between a first state and a second state using the power supply position-switching device. In the first state, the first power source terminal is connected with the first heater terminal of the first heater, the second power source terminal is connected with the third heater terminal of the second heater, and the second heater terminal of the first heater is directly or indirectly connected with the fourth heater terminal of the second heater. In the second state, the first power source terminal is connected with the second heater terminal of the first heater, the second power source terminal is connected with the fourth heater terminal of the second heater, and the first heater terminal of the first heater is directly or indirectly connected with the third heater terminal of the second heater.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1A is a view schematically illustrating the first state in a heater unit according to the first embodiment of the present invention. FIG. 1B is a view schematically illustrating the second state in a heater unit according to the first embodiment of the present invention.

FIG. 2 is a cross-sectional view schematically illustrating the inside of the casing in the firing furnace according to the first embodiment of the present invention.

FIG. 3A is a view schematically illustrating the first state in the heater unit according to the second embodiment of the present invention. FIG. 3B is a view schematically illustrating the second state in the heater unit according to the second embodiment of the present invention.

FIG. 4 is a front view schematically illustrating an example of a continuous firing furnace.

FIG. 5 is an A-A line cross-sectional view of a high-temperature firing segment of the continuous firing furnace shown in FIG. 4.

FIG. 6 is a perspective view schematically illustrating an example of a honeycomb structure according to the embodiments of the present invention.

FIG. 7A is a perspective view schematically illustrating an example of a honeycomb fired body, and FIG. 7B is a B-B line cross-sectional view of FIG. 7A.

### DESCRIPTION OF THE EMBODIMENTS

In the heater unit according to the embodiment of the present invention includes

a power source including a first terminal and a second terminal,

a plurality of heaters connected in series with the power source, and

a power supply position-switching device,

wherein the plurality of heaters include a first heater connected to the first terminal of the power source and a second heater connected to the second terminal of the power source, the first heater having a first terminal and a second terminal, the second heater having a third terminal and a fourth terminal, and

the power supply position-switching device is a device to switch between

a first state in which the first terminal of the power source is connected with the first terminal of the first heater; the second terminal of the power source is connected with the third terminal of the second heater; and the second terminal of the first heater is connected with the fourth terminal of the second heater, and

a second state in which the first terminal of the power source is connected with the second terminal of the first heater; the second terminal of the power source is connected with the fourth terminal of the second heater; and the first terminal of the first heater is connected with the third terminal of the second heater.

In the first state, the potentials are likely to be high at the first terminal side of the first heater and at the third terminal side of the second heater. In the second state, the potentials are likely to be high at the second terminal side of the first heater and at the fourth terminal side of the second heater. In the heaters, a part with a higher potential is likely to have a higher thermionic electron energy, and tends to be silicified. Thus, if the heater unit includes a power supply position-switching device to switch between the first state and the second state, a high potential part of the heaters, i.e., an easily silicified part on the surface of the heaters, is switched so that the heater is likely to be more easily allowed to uniformly wear out through the entire body thereof. As a result, damage derived from local wear-out of the heaters is prevented from occurring, and thus the life of the heaters is likely to be more easily increased.

In the heater unit according to the embodiment of the present invention, the heaters each preferably include a plurality of resistance heating elements connected in parallel with the power source.

When the heaters each include a plurality of resistance heating elements connected in parallel with the power source, even if some of the resistance heating elements are damaged and disabled, the rest resistance heating elements are likely to more easily continue heat generation upon being supplied with electric current. Therefore, all the heaters supplied with electric current are likely to more easily continue heat generation. Thereby, drop of the temperature in the heater unit is likely to be more easily minimized.

Preferably, the plurality of heaters are arranged adjacent to one another in the heater unit according to the embodiment of the present invention.

Since the plurality of heaters are adjacent to one another, the size of the heater unit is likely to be more easily reduced.

Preferably, the resistance heating elements are formed of carbon in the heater unit according to the embodiment of the present invention.

Since the resistance heating elements are likely to be excellent in heat resistance when they are formed of carbon, the heater unit is likely to be more easily used in high temperature environment.

The heater unit according to the embodiment of the present invention is preferably the heater unit further including a transformer.

If the heater unit further includes a transformer, the temperature of the heater unit is likely to be more easily further raised.

The firing furnace according the embodiment of the present invention includes

a power source including a first terminal and a second terminal,

a casing,

a firing chamber disposed in the casing,

a plurality of heaters disposed in the casing and connected in series with the power source, and

a power supply position-switching device,

wherein the plurality of heaters include a first heater connected to the first terminal of the power source and a second heater connected to the second terminal of the power source, the first heater having a first terminal and a second terminal, the second heater having a third terminal and a fourth terminal, and

the power supply position-switching device is a device to switch between

a first state in which the first terminal of the power source is connected with the first terminal of the first heater; the second terminal of the power source is connected with the third terminal of the second heater; and the second terminal of the first heater is connected with the fourth terminal of the second heater, and

a second state in which the first terminal of the power source is connected with the second terminal of the first heater; the second terminal of the power source is connected with the fourth terminal of the second heater; and the first terminal of the first heater is connected with the third terminal of the second heater.

In the first state, the potentials are likely to be high at the first terminal side of the first heater and at the third terminal side of the second heater. In the second state, the potentials are likely to be high at the second terminal side of the first heater and at the fourth terminal side of the second heater. In the heaters, a part with a higher potential has a higher thermionic electron energy, and tends to be silicified. Thus, if the firing furnace includes a power supply position-switching device to switch between the first state and the second state, a high potential part of the heaters, i.e., an easily silicified part on the surface of the heaters, is switched so that the heater is likely to be more easily allowed to substantially uniformly wear out through the entire body thereof. As a result, damage derived from local wear-out of the heaters is less likely to occur, and thus the life of the heaters is likely to be more easily increased.

In the firing furnace according to the embodiment of the present invention, the heaters each preferably include a plurality of resistance heating elements connected in parallel with the power source.

When the heaters each include a plurality of resistance heating elements connected in parallel with the power source, even if some of the resistance heating elements are damaged and disabled, the rest resistance heating elements are likely to more easily continue heat generation upon being supplied with electric current. Therefore, all the heaters supplied with electric current are likely to more easily continue heat generation. Thereby, drop of the temperature in the firing furnace is likely to be more easily minimized.

The plurality of heaters are preferably arranged adjacent to one another in the firing furnace according to the embodiment of the present invention.

Since the plurality of heaters are adjacent to one another, the size of the firing furnace is likely to be more easily reduced.

The resistance heating elements are preferably formed of carbon in the firing furnace according to the embodiment of the present invention.

Since the resistance heating elements are likely to be excellent in heat resistance when they are formed of carbon, the firing furnace is likely to be more easily used in high temperature environment.

The firing furnace according to the embodiment of the present invention is preferably the firing furnace further including a transformer.

If the firing furnace further includes a transformer, the temperature of the firing furnace is likely to be more easily raised further.

The firing furnace according to the embodiment of the present invention is preferably a continuous firing furnace which continuously fires a plurality of subjects which are to be fired while conveying the subjects.

The continuous firing furnace is likely to enable to significantly increase the productivity in mass production of ceramic goods as compared with conventional batch-type furnaces.

The method of manufacturing a silicon-containing porous ceramic fired body according to the embodiment of the present invention is a method of manufacturing a silicon-containing porous ceramic fired body, including the steps of

preparing a subject to be fired from a composition containing silicon-containing ceramic powders, and

firing the subject using a firing furnace, the firing furnace including a power source including a first terminal and a second terminal, a casing, a firing chamber disposed in the casing, a plurality of heaters disposed in the casing and connected in series with the power source, and a power supply position-switching device,

wherein the plurality of heaters include a first heater connected to the first terminal of the power source and a second heater connected to the second terminal of the power source, the first heater having a first terminal and a second terminal, the second heater having a third terminal and a fourth terminal, and

the power supply position-switching device is a device to switch between a first state in which the first terminal of the power source is connected with the first terminal of the first heater; the second terminal of the power source is connected with the third terminal of the second heater; and the second terminal of the first heater is connected with the fourth terminal of the second heater, and a second state in which the first terminal of the power source is connected with the second terminal of the first heater; the second terminal of the power source is connected with the fourth terminal of the second heater; and the first terminal of the first heater is connected with the third terminal of the second heater.

The method of manufacturing a silicon-containing porous ceramic fired body according to the embodiment of the present invention is likely to enable to increase the life of heaters in the step of firing the subject. Therefore, frequency of heater exchange is likely to be more easily reduced.

In the method of manufacturing a silicon-containing porous ceramic fired body according to the embodiment of the present invention, preferably the heaters each include a plurality of resistance heating elements connected in parallel with the power source.

When the heaters each include a plurality of resistance heating elements connected in parallel with the power source, even if some of the resistance heating elements are damaged and disabled, the rest resistance heating elements are likely to more easily continue heat generation upon being supplied with electric current.

Therefore, all the heaters supplied with electric current are likely to more easily continue heat generation. Thereby, the subject can be fired while minimizing drop of the temperature in the firing furnace.

Preferably, the plurality of heaters are arranged adjacent to one another in the method of manufacturing a silicon-containing porous ceramic fired body according to the embodiment of the present invention.

The adjacent arrangement of the plurality of heaters is likely to more easily make it possible to efficiently fire the subject.

Preferably, the resistance heating elements are formed of carbon in the method of manufacturing a silicon-containing porous ceramic fired body according to the embodiment of the present invention.

Since the resistance heating elements are likely to be excellent in heat resistance when they are formed of carbon, the subject is likely to be more easily fired at a higher temperature in the firing furnace.

In the method of manufacturing a silicon-containing porous ceramic fired body according to the embodiment of the present invention, the silicon-containing porous ceramic fired body preferably includes porous silicon carbide or porous silicon nitride.

If the silicon-containing porous ceramic fired body including porous silicon carbide or porous silicon nitride is used, ceramic fired bodies are likely to be more easily manufactured preferably by the method of manufacturing a silicon-containing porous ceramic fired body of the embodiment of the present invention.

The firing furnace in the method of manufacturing a silicon-containing porous ceramic fired body according to the embodiment of the present invention is preferably a continuous firing furnace which continuously fires a plurality of subjects which are to be fired while conveying the subjects.

The continuous firing furnace is likely to more easily enable to significantly increase the productivity in mass production of ceramic goods as compared with conventional batch-type furnaces.

The embodiments will now be described with reference to the accompanying drawings, wherein like reference numerals designate corresponding or identical elements throughout the various drawings. However, the present invention is not limited by examples below, and may be appropriately changed within the scope not changing the subject matter of the present invention.

### First Embodiment

The following will discuss the first embodiment of the present invention that is one embodiment of the heater unit, firing furnace, and method of manufacturing silicon-containing porous ceramic fired body of the present invention.

First, the heater unit according to the embodiment of the present invention is explained below.

The heater unit according to the embodiment of the present invention includes

a power source including a first terminal and a second terminal,

a plurality of heaters connected in series with the power source, and

a power supply position-switching device,

wherein the plurality of heaters include a first heater connected to the first terminal of the power source and a second heater connected to the second terminal of the power source, the first heater having a first terminal and a second terminal, the second heater having a third terminal and a fourth terminal, and

the power supply position-switching device is a device to switch between

a first state in which the first terminal of the power source is connected with the first terminal of the first heater; the second terminal of the power source is connected with the third terminal of the second heater; and the second terminal of the first heater is connected with the fourth terminal of the second heater, and

a second state in which the first terminal of the power source is connected with the second terminal of the first heater; the second terminal of the power source is connected with the fourth terminal of the second heater; and the first terminal of the first heater is connected with the third terminal of the second heater.

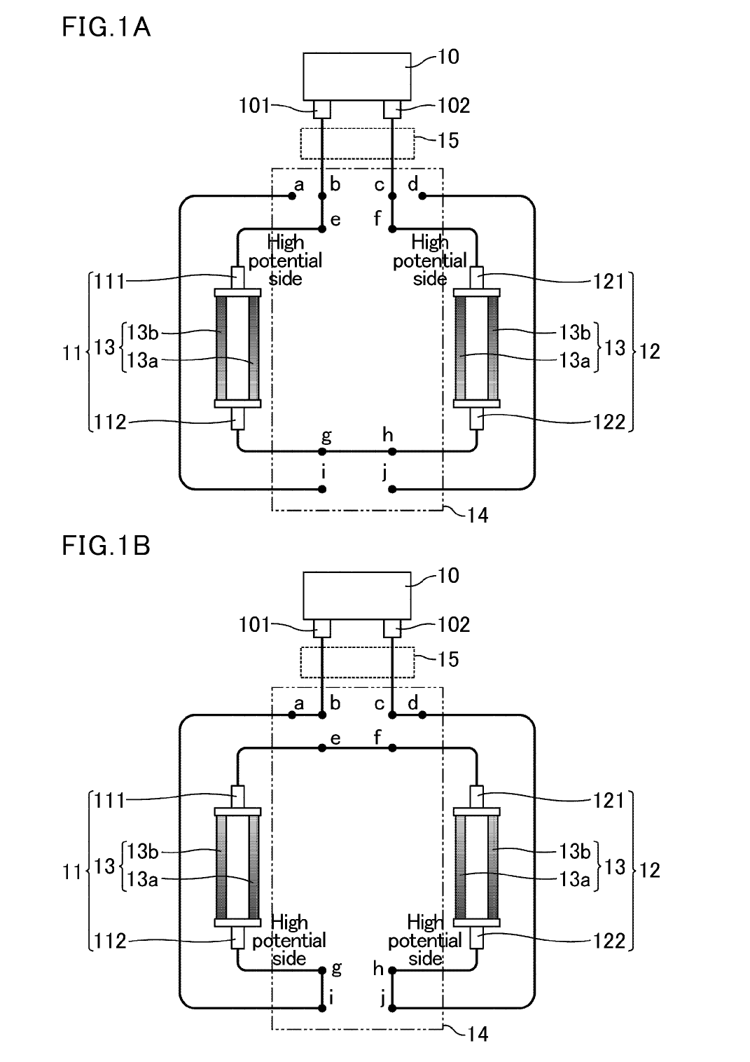

FIG. 1A is a view schematically illustrating the first state in the heater unit according to the first embodiment of the present invention. FIG. 1B is a view schematically illustrating the second state in the heater unit according to the first embodiment of the present invention.

The heater unit according to the embodiment of the present invention shown in FIG. 1A and FIG. 1B includes a power source 10 including a first terminal 101 and a second terminal 102.

The heater unit according to the embodiment of the present invention shown in FIG. 1A and FIG. 1B includes a first heater 11 and a second heater 12 which are connected in series with the power source 10. The first heater 11 connected to the first terminal 101 of the power source 10 has a first terminal 111 and a second terminal 112. The second heater 12 connected to the second terminal 102 of the power source 10 has a third terminal 121 and a fourth terminal 122.

In the heater unit according to the embodiment of the present invention, the first heater 11 and the second heater 12 each preferably include a plurality of resistance heating elements 13 which are connected in parallel with one another. In the heater unit shown in FIG. 1A and FIG. 1B, the first heater 11 and the second heater 12 each preferably include two resistance heating elements 13a and 13b which are connected in parallel with each other. The number of the resistance heating elements 13 is not particularly limited, and may be three or more. The resistance heating elements 13a and 13b are made of the same materials and have the same shape.

The resistance heating elements 13 are preferably formed of carbon that has excellent heat resistance, and preferably graphite.

Preferably, the resistance heating elements 13 each have a substantially round-pillar shape or a substantially rectangular-pillar shape, and more preferably a substantially round-pillar shape. The longitudinal axis of the resistance heating elements 13 preferably extends in a direction from the first terminal 111 to the second terminal 112 of the first heater 11.

The first heater 11 and the second heater 12 are preferably adjacent to each other. In the heater unit shown in FIG. 1A and FIG. 1B, the first heater 11 and the second heater 12 are adjacent to each other in a manner that the first terminal 111 of the first heater 11 is adjacent to the third terminal 121 of the second heater 12, and the second terminal 112 of the first heater 11 is adjacent to the fourth terminal 122 of the second heater 12. The directions of the first heater 11 and the second heater 12 are not particularly limited. The first heater 11 and the second heater 12 may be adjacent to each other in a manner that the first terminal 111 of the first heater 11 is adjacent to the fourth terminal 122 of the second heater 12, and the second terminal 112 of the first heater 11 is adjacent to the third terminal 121 of the second heater 12.

The heater unit according to the embodiment of the present invention further includes a power supply position-switching device 14 to switch between the first state shown in FIG. 1A and the second state shown in FIG. 1B.

The system to switch between the first state and the second state is not particularly limited, and may use a conventionally-known magnet switch, or the like.

The method to switch between the first state and the second state is not particularly limited, and may be manually switched or switched using an automatic timer.

Preferably, the heater unit further includes a transformer 15. The transformer 15 is disposed between the first terminal 101 of the power source 10 and a junction b on the circuit, and between the second terminal 102 of the power source 10 and a junction c on the circuit, as shown by dotted lines in FIG. 1A and FIG. 1B.

In the first state of the heater unit according to the embodiment of the present invention shown in FIG. 1A, the first terminal 101 of the power source 10 is connected with the first terminal 111 of the first heater 11; the second terminal 102 of the power source 10 is connected with the third terminal 121 of the second heater 12; and the second terminal 112 of the first heater 11 is connected with the fourth terminal 122 of the second heater 12.

In this state, the potentials are high at the first terminal 111 side of the first heater 11 and at the third terminal 121 side of the second heater 12, and silicification tends to occur on the surface of the resistance heating elements 13. Meanwhile, the color intensity of the resistance heating elements 13 shown in FIG. 1A expresses the strength of the potential. A higher color intensity indicates a higher potential.

In the second state of the heater unit according to the embodiment of the present invention shown in FIG. 1B, the first terminal 101 of the power source 10 is connected with the second terminal 112 of the first heater 11; the second terminal 102 of the power source 10 is connected with the fourth terminal 122 of the second heater 12; and the first terminal 111 of the first heater 11 is connected with the third terminal 121 of the second heater 12.

In this case, the potentials are high at the second terminal 112 side of the first heater 11 and the fourth terminal 122 side of the second heater 12, and silicification tends to occur on the surface of the heaters. Meanwhile, the color intensity of the resistance heating elements 13 shown in FIG. 1B expresses the strength of the potential. A higher color intensity indicates a higher potential.

The power supply position-switching device 14 shown by alternate long and two short dashes line in FIG. 1A and FIG. 1B is a device to switch the connection of a circuit including junctions a to j. Specifically, in the first state shown in FIG. 1A, the junctions b to e, c to f, and g to h are connected. In the second state shown in FIG. 1B, the connections are changed so that the junctions a to b, c to d, e to f, g to i, and h to j are connected.

In the heater unit according to the embodiment of the present invention, switching between the first state and the second state is preferably performed every about 168 operation hours to about 336 operation hours.

If the switching between the first state and the second state is performed before about 336 operation hours, damage derived from local wear-out of the heater tends not to occur, and thus the life of the heater is likely to be more easily increased.

If the switching between the first state and the second state is performed after about 168 operation hours, the switching frequency tends not to increase, which is less likely to deteriorate the workability.

Next, the firing furnace according to the embodiment of the present invention is explained below.

The firing furnace according to the embodiment of the present invention includes a power source including a first terminal and a second terminal,

a casing,

a firing chamber disposed in the casing,

a plurality of heaters disposed in the casing and connected in series with the power source, and

a power supply position-switching device,

wherein the plurality of heaters include a first heater connected to the first terminal of the power source and a second heater connected to the second terminal of the power source, the first heater having a first terminal and a second terminal, the second heater having a third terminal and a fourth terminal, and

the power supply position-switching device is a device to switch between

a first state in which the first terminal of the power source is connected with the first terminal of the first heater; the second terminal of the power source is connected with the third terminal of the second heater; and the second terminal of the first heater is connected with the fourth terminal of the second heater, and

a second state in which the first terminal of the power source is connected with the second terminal of the first heater; the second terminal of the power source is connected with the fourth terminal of the second heater; and the first terminal of the first heater is connected with the third terminal of the second heater.

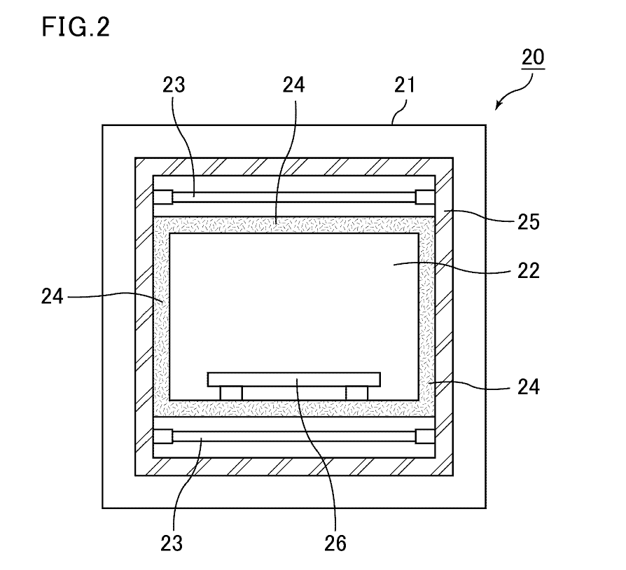

FIG. 2 is a cross-sectional view schematically illustrating the inside of the casing in the firing furnace according to the first embodiment of the present invention.

A firing furnace 20 according to the embodiment of the present invention shown in FIG. 2 includes a casing 21, a firing chamber 22 disposed in the casing 21, and a plurality of heaters 23 disposed in the casing 21.

Moreover, the firing furnace 20 according to the embodiment of the present invention includes the power source 10 and the power supply position-switching device 14 of the heater unit according to the embodiment of the present invention shown in FIG. 1A and FIG. 1B. The positions of the power source 10 and the power supply position-switching device 14 with the casing 21 are not particularly limited, however; they are preferably disposed outside the casing 21.

The power supply position-switching device 14 is almost the same as that of the heater unit according to the embodiment of the present invention, and thus detailed explanation thereof is omitted.

The firing chamber 22 is sectioned by a furnace wall 24. The furnace wall 24 is preferably formed of highly heat resistant materials such as carbon.

A supporting table 26 for placing a subject to be fired is mounted at the bottom inside the firing furnace 22.

Preferably, a heat-insulating layer 25 formed of carbon fibers or the like is provided between the casing 21 and the furnace wall 24 to prevent the tendency of deteriorating and damaging metallic parts of the casing 21 due to the heat of the firing chamber 22.

The plurality of heaters 23 correspond to the first heater 11 and the second heater 12 of the heater unit according to the embodiment of the present invention shown in FIG. 1A and FIG. 1B.

The plurality of heaters 23 are preferably disposed at an upper side and a lower side of the firing chamber 22. In other words, the plurality of heaters 23 are preferably disposed in a manner sandwiching a subject to be fired in the firing chamber 22.

The number of the heaters 23 disposed at an upper side and a lower side of the firing chamber 22 is not particularly limited. For example, a set of the first heater 11 and the second heater 12 (i.e. two heaters 23) shown in FIG. 1A and FIG. 1B may be provided at both of an upper side and a lower side of the firing chamber 22. Moreover, for example, the first heater 11 and the second heater 12 may be disposed at an upper side and a lower side, respectively, of the firing chamber 22.

The plurality of heaters 23 are preferably, though not particularly limited, disposed outside the furnace wall 24. If the plurality of heaters 23 are disposed outside the furnace wall 24, the whole furnace wall 24 is firstly heated, which is likely to more easily enable to uniformly increase the temperature inside the firing chamber 22.

The firing furnace 20 preferably includes the transformer 15. The transformer 15 is disposed between the first terminal 101 of the power source 10 and the junction b on the circuit, and between the second terminal 102 of the power source 10 and the joint c on the circuit, as shown by dotted lines in FIG. 1A and FIG. 1B. In other words, the transformer 15 is preferably disposed outside the casing 21, as in the same manner as the power source 10 and the power supply position-switching device 14.

Finally, a method of manufacturing a silicon-containing porous ceramic fired body according to the embodiment of the present invention is explained below.

The method of manufacturing a silicon-containing porous ceramic fired body according to the embodiment of the present invention includes the steps of

preparing a subject to be fired from a composition containing silicon-containing ceramic powders, and

firing the subject using a firing furnace, the firing furnace including a power source including a first terminal and a second terminal, a casing, a firing chamber disposed in the casing, a plurality of heaters disposed in the casing and connected in series with the power source, and a power supply position-switching device,

wherein the plurality of heaters include a first heater connected to the first terminal of the power source and a second heater connected to the second terminal of the power source, the first heater having a first terminal and a second terminal, the second heater having a third terminal and a fourth terminal, and

the power supply position-switching device is a device to switch between a first state in which the first terminal of the power source is connected with the first terminal of the first heater; the second terminal of the power source is connected with the third terminal of the second heater; and the second terminal of the first heater is connected with the fourth terminal of the second heater, and a second state in which the first terminal of the power source is connected with the second terminal of the first heater; the second terminal of the power source is connected with the fourth terminal of the second heater; and the first terminal of the first heater is connected with the third terminal of the second heater.

(1) In the method of manufacturing a silicon-containing porous ceramic fired body according to the embodiment of the present invention, firstly a subject to be fired is prepared from a composition containing silicon-containing ceramic powders.

Specifically, a wet mixture prepared by mixing silicon-containing ceramic powders having different average particle diameters, an organic binder, a liquid plasticizer, a lubricant, and water is molded to prepare a ceramic molded body. The ceramic molded body is dried and then degreased at a predetermined temperature so that organic matters in the molded body are removed by the heating. Thereby, a subject to be fired is prepared.

Meanwhile, the silicon-containing ceramic powders are ceramic powders containing silicon such as silicon carbide and silicon nitride. Firing the subject containing the ceramic powders in a subsequent firing step generates an SiO gas.

(2) Next, the prepared subject is put in a firing furnace to be fired.

This firing furnace is substantially the same as that of the firing furnace according to the embodiment of the present invention, and thus explanation thereof is omitted. Moreover, an applicable firing condition may include conventional firing conditions used for preparing a ceramic fired body.

Meanwhile, when the subject formed of the silicon-containing porous ceramic powders is fired, for example, at a temperature of from about 2190° C. to about 2210° C. for about 0.1 hours to about 5 hours, an SiO gas is generated.

In the method of manufacturing a silicon-containing porous ceramic fired body according to the embodiment of the present invention, for continuous manufacturing of a plurality of silicon-containing porous ceramic fired bodies, the power supply position-switching device is manipulated to switch between the first state and the second state in the step of firing subjects to be fired.

The firing furnace used in the method of manufacturing a silicon-containing porous ceramic fired body according to the embodiment of the present invention includes a power supply position-switching device 14 to switch between the first state shown in FIG. 1A and the second state shown in FIG. 1B.

In the first state, as shown in FIG. 1A, the first terminal 101 of the power source 10 is connected with the first terminal 111 of the first heater 11; the second terminal 102 of the power source 10 is connected with the third terminal 121 of the second heater 12; and the second terminal 112 of the first heater 11 is connected with the fourth terminal 122 of the second heater 12.

In the second state, as shown in FIG. 1B, the first terminal 101 of the power source 10 is connected with the second terminal 112 of the first heater 11; the second terminal 102 of the power source 10 is connected with the fourth terminal 122 of the second heater 12; and the first terminal 111 of the first heater 11 is connected with the third terminal 121 of the second heater 12.

The following will specifically describe the switching between the first state and the second state.

The power supply position-switching device 14 can switch the first state in which the junctions b to e, c to f, and g to h are connected as shown in FIG. 1A to the second state in which the junctions a to b, c to d, e to f, g to i, and h to j are connected as shown in FIG. 1B.

The system to switch between the first state and the second state is not particularly limited, and may use a conventionally-known magnet switch, or the like.

The method to switch between the first state and the second state is not particularly limited, and may be manually switched or switched using an automatic timer.

Switching between the first state and the second state is preferably performed every about 168 operation hours to about 336 operation hours.

If the switching between the first state and the second state is performed before about 336 operation hours, damage derived from local wear-out of the heater tends not to occur, and thus the life of the heater is likely to be more easily increased.

If the switching between the first state and the second state is performed after about 168 operation hours, the switching frequency tends not to increase, which is less likely to deteriorate the workability.

The silicon-containing porous ceramic fired body that can be manufactured by the method of manufacturing a silicon-containing porous ceramic fired body according to the embodiment of the present invention preferably includes porous silicon carbide or porous silicon nitride.

The following will list the functional effects of the heater unit, firing furnace, and method of manufacturing silicon-containing porous ceramic fired body according to the first embodiment of the present invention.

(1) The heater unit and the firing furnace according to the embodiment of the present invention include the power supply position-switching device to switch between the first state and the second state.

In the first state, the potentials are likely to be high at the first terminal side of the first heater and at the third terminal side of the second heater. In the second state, the potentials are likely to be high at the second terminal side of the first heater and at the fourth terminal side of the second heater. In the heaters, a part with a higher potential tends to have a higher thermionic electron energy, and tends to be silicified. Thus, if the heater unit includes a power supply position-switching device to switch between the first state and the second state, a high potential part of the heaters, i.e., an easily silicified part on the surface of the heaters, is switched so that the heater is likely to be more easily allowed to substantially uniformly wear out through the entire body thereof. As a result, damage derived from local wear-out of the heaters is less likely to occur, and thus the life of the heaters is likely to be more easily increased.

(2) In the heater unit and the firing furnace according to the embodiment of the present invention, the heaters each includes a plurality of resistance heating elements connected in parallel with the power source.

When the heaters each include a plurality of resistance heating elements connected in parallel with the power source, even if some of the resistance heating elements are damaged and disabled, the rest resistance heating elements are likely to more easily continue heat generation upon being supplied with electric current. Therefore, all the heaters supplied with electric current is likely to more easily continue heat generation. Thereby, drop of the temperature in the heater unit is likely to be more easily minimized.

(3) In the heater unit and firing furnace according to the embodiment of the present invention, the plurality of heaters are disposed adjacent to one another.

Since the plurality of heaters are adjacent to one another, the size of the heater unit is likely to be more easily reduced.

(4) In the heater unit and firing furnace according to the embodiment of the present invention, the resistance heating elements are formed of carbon.

Since the resistance heating elements are likely to be excellent in heat resistance when they are formed of carbon, the heater unit is likely to be more easily used in high temperature environment.

(5) In the heater unit and firing furnace according to the embodiment of the present invention, the heater unit and firing furnace each include a transformer.

If the heater unit and firing furnace each further include a transformer, the temperature of the heater unit and firing furnace, respectively, are likely to be more easily increased further.

(6) The method of manufacturing a silicon-containing porous ceramic fired body according to the embodiment of the present invention includes a step of firing a subject to be fired using a firing furnace which includes a power supply position-switching device to switch between the first state and the second state.

This is likely to more easily enable to increase the life of heaters in the step of firing a subject to be fired, and thus frequency of heater exchange is likely to be more easily reduced.

(7) In the method of manufacturing a silicon-containing porous ceramic fired body according to the embodiment of the present invention, the silicon-containing porous ceramic fired body includes porous silicon carbide or porous silicon nitride.

If the silicon-containing porous ceramic fired body including porous silicon carbide or porous silicon nitride is used, ceramic fired bodies are likely to be more easily preferably manufactured by the method of manufacturing a silicon-containing porous ceramic fired body of the embodiment of the present invention.

### Second Embodiment

The following will discuss the second embodiment of the present invention that is one embodiment of the heater unit, firing furnace, and method of manufacturing a silicon-containing porous ceramic fired body of the present invention.

The heater unit, firing furnace, and method of manufacturing a silicon-containing porous ceramic body according to the second embodiment of the present invention are substantially the same as those of the first embodiment of the present invention, except that three heaters are connected in series with the power source.

Therefore, only the heater unit including three heaters connected in series with the power source will be specifically described, and description of other parts will be omitted.

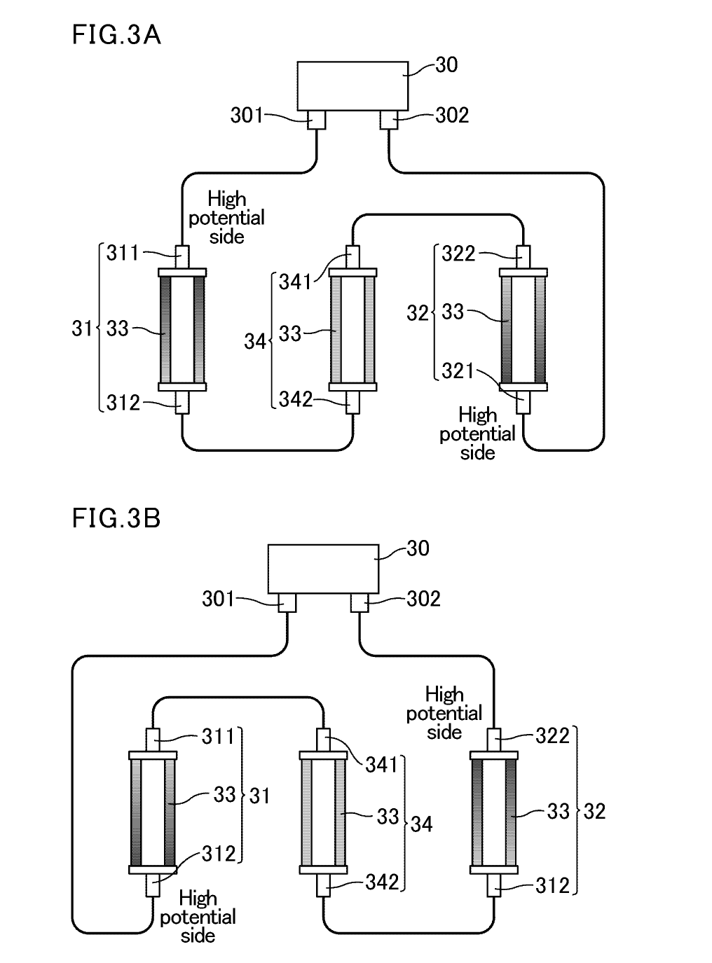

FIG. 3A is a view schematically illustrating the first state in the heater unit according to the second embodiment of the present invention. FIG. 3B is a view schematically illustrating the second state in the heater unit according to the second embodiment of the present invention.

The heater unit according to the embodiment of the present invention shown in FIG. 3A and FIG. 3B includes a power source 30 including a first terminal 301 and a second terminal 302.

The heater unit according to the embodiment of the present invention shown in FIG. 3A and FIG. 3B includes a first heater 31, a second heater 32, and a third heater 34 which are connected in series with the power source 30. The first heater 31 connected to the first terminal 301 of the power source 30 has a first terminal 311 and a second terminal 312. The second heater 32 connected to the second terminal 302 of the power source 30 has a third terminal 321 and a fourth terminal 322. The third heater 34 connected between the first heater 31 and the second heater 32 has a fifth terminal 341 and a sixth terminal 342.

In the first state of the heater unit according to the embodiment of the present invention shown in FIG. 3A, the first terminal 301 of the power source 30 is connected with the first terminal 311 of the first heater 31; the second terminal 302 of the power source 30 is connected with the third terminal 321 of the second heater 32; the second terminal 312 of the first heater 31 is connected with the sixth terminal 342 of the third heater 34; and the fourth terminal 322 of the second heater 32 is connected with the fifth terminal 341 of the third heater 34. In this state, the potentials are high at the first terminal 311 side of the first heater 31 and at the third terminal 321 side of the second heater 32, and silicification tends to occur on the surface of the heaters. In the third heater 34, the potentials are balanced each other to zero, and thus silicification tends not to occur on the surface of the heaters. The color intensity of the resistance heating elements 33 shown in FIG. 3A expresses the strength of the potential. A higher color intensity indicates a higher potential.

In the second state of the heater unit according to the embodiment of the present invention shown in FIG. 3B, the first terminal 301 of the power source 30 is connected with the second terminal 312 of the first heater 31; the second terminal 302 of the power source 30 is connected with the fourth terminal 322 of the second heater 32; the first terminal 311 of the first heater 31 is connected with the fifth terminal 341 of the third heater 34; and the third terminal 321 of the second heater 32 is connected with sixth terminal 342 of the third heater 34. In this state, the potentials are high at the second terminal 312 side of the first heater 31 and the fourth terminal 322 side of the second heater 32, and silicification tends to occur on the surface of the heaters.

In the third heater 34, the potentials are balanced each other to zero, and thus silicification tends not to occur on the surface of the heaters. The color intensity of the resistance heating elements 33 shown in FIG. 3B expresses the strength of the potential. A higher color intensity indicates a higher potential.

In the embodiment of the present invention, the functional effects (1) to (7) described in the first embodiment of the present invention can be exerted.

### Other Embodiments

According to the firing furnace and method of manufacturing a silicon-containing porous ceramic fired body, the firing furnace may be a continuous firing furnace. The following will describe a continuous firing furnace.

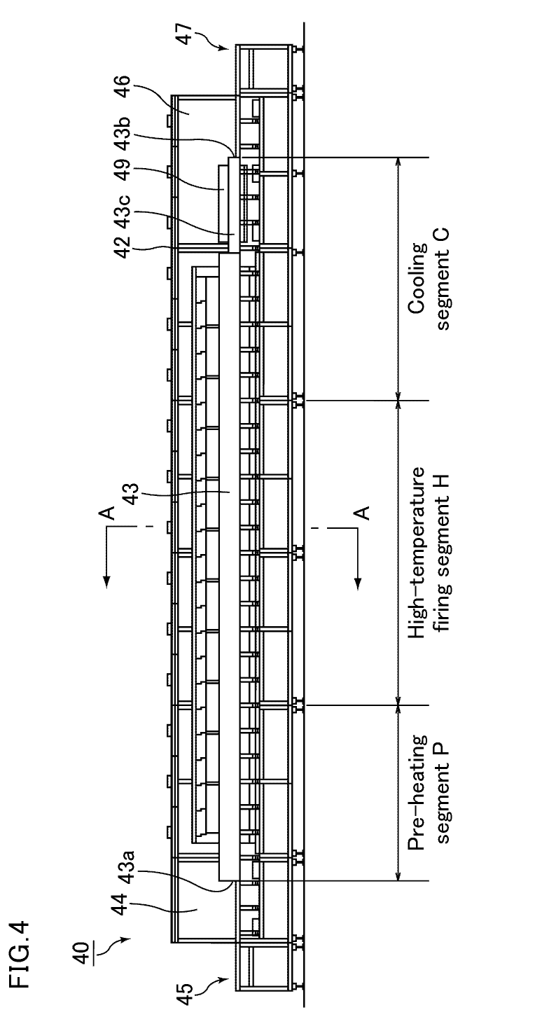

FIG. 4 is a front view schematically illustrating an example of a continuous firing furnace.

A continuous firing furnace 40 shown in FIG. 4 includes a horizontally-long main frame 42 in a large part of which, other than a receiving port 45 and a discharging port 47, a tubular firing chamber 43 made of heat-resistant materials is horizontally supported. In the vicinity of an entrance 43a of the firing chamber 43, an entrance purge chamber 44 is provided. The receiving port 45 is disposed at a side closer to a prior stage than the entrance purge chamber 44, namely at a left side of FIG. 4. A cooling jacket functioning 49 as a cooler is provided at a rear end part 43c of the firing chamber 43. In the vicinity of an exit 43b of the firing chamber 43, an exit purge chamber 46 is provided. The discharging port 47 is disposed at a side closer to a posterior stage than the exit purge chamber 46, namely at a right side of FIG. 4.

A conveyor mechanism for conveying subjects too be fired is laid inside the firing chamber 43. Subjects are moved by activating the conveyor mechanism from the entrance 43a to the exit 43b, namely, from the left side to the right side of FIG. 4.

The region where the firing chamber 43 is placed in the continuous firing furnace 40 is sectioned into a pre-heating segment P, a high-temperature firing segment H, and a cooling segment C, in said order from left to right in FIG. 4.

The pre-heating segment P is a segment for preheating treatment in which a ceramic degreased body is heated from room temperature to a preheating temperature of from about 150° C. to about 2000° C.

The high-temperature firing segment H is a segment for high-temperature firing treatment in which the ceramic degreased body is heated from the pre-heating temperature to a firing temperature of from about 2000° C. to about 2300° C., and further the temperature of the ceramic degreased body is maintained at the firing temperature.

The cooling segment C is a segment for cooling treatment in which the ceramic degreased body having passed through the high-temperature firing treatment is cooled to room temperature.

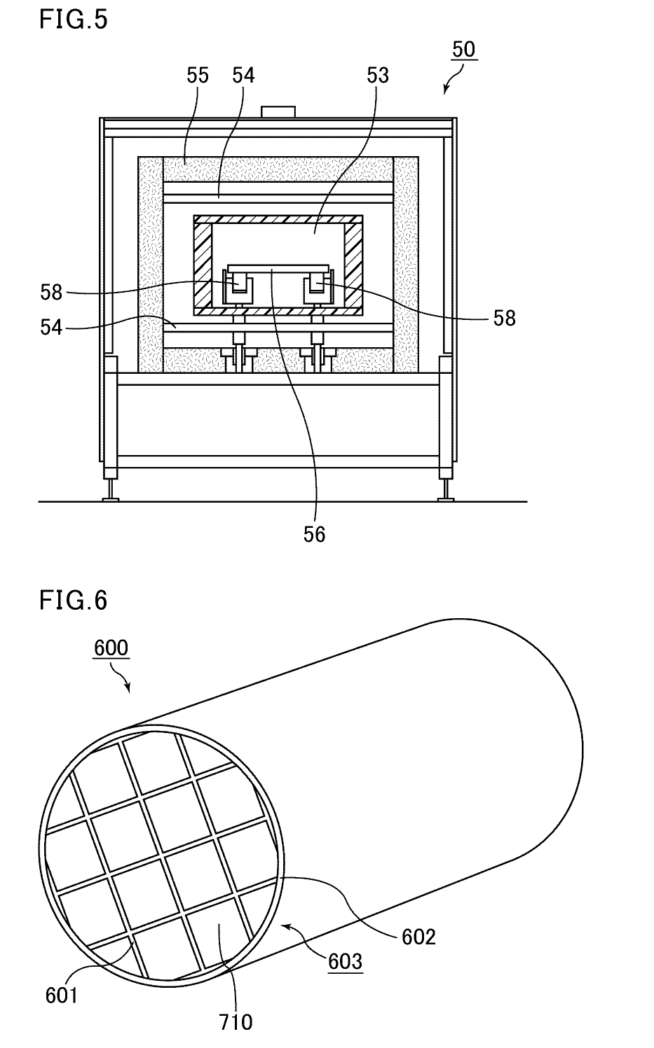

FIG. 5 is an A-A line cross-sectional view of the high-temperature firing segment H of the continuous firing furnace shown in FIG. 4.

The high-temperature firing segment H shown in FIG. 5 is provided with a firing chamber 53 at the center of the cross-section thereof. Two rows of rollers 58 functioning as a conveyor mechanism are laid on the bottom of the firing chamber 53.

A supporting table 56 for placing subjects to be fired is mounted on the rollers 58.

The rollers 58 are provided in plural numbers in the longitudinal direction of the continuous firing furnace (lateral direction in FIG. 4). Subjects and the supporting table 56 can be conveyed to the firing chamber 53 by activating the rollers 58.

The plurality of heaters 54 shown in FIG. 5 correspond to the first heater 11 and the second heater 12 in the heater unit according to the first embodiment of the present invention shown in FIG. 1A and FIG. 1B.

The plurality of heaters 54 are preferably disposed at an upper side and a lower side of the firing chamber 53. In other words, the plurality of heaters 54 are disposed in a manner sandwiching subjects to be fired in the firing chamber 53.

The number of the heaters 54 disposed at an upper side and a lower side of the firing chamber 53 is not particularly limited. For example, plural sets of the first heater 11 and the second heater 12 (i.e. two heaters 23 shown in FIG. 1A and FIG. 1B) maybe provided at both of an upper side and a lower side of the firing chamber 22. Moreover, for example, a plurality of the first heaters 11 are disposed only at an upper side of the firing chamber 22, and a plurality of the second heaters 12 are disposed only at a lower side of the firing chamber 22.

Other structures are substantially the same as those of the firing furnace according to the first embodiment of the present invention, and thus explanations thereof are omitted.

The functional effect described below as well as the functional effects (1) to (7) described in the first embodiment of the present invention can be exerted in the embodiment of the present invention.

(8) In the firing furnace and the method of manufacturing a silicon-containing porous ceramic fired body according to the embodiment of the present invention, the firing furnace is a continuous firing furnace which continuously fires a plurality of subjects which are to be fired while conveying the subjects.

Use of the continuous firing furnace enables to significantly increase the productivity in mass production of ceramic goods as compared with conventional batch-type furnaces.

In the heater unit according to the first embodiment of the present invention, the first heater 11 and the second heater 12 each include the resistance heating elements 13a and 13b which are connected in parallel with each other. The resistance heating elements 13a and 13b may be connected in series with each other.

In the heater unit, firing furnace, and method of manufacturing a silicon-containing porous ceramic fired body of the present invention, the number of heaters included in the heater unit and the firing furnace is not limited to two or three, but may be four or more.

In the firing furnace of the embodiment of the present invention, the plurality of heaters may be disposed at a left side and a right side of the firing furnace as long as the heaters sandwich a subject to be fired in the firing furnace. Moreover, the plurality of heaters maybe disposed at an upper side, a lower side, a left side, and/or a right side of the firing furnace.

In the method of manufacturing a silicon-containing porous ceramic fired body of the embodiment of the present invention, the ceramic fired body may be a honeycomb fired body.

The ceramic degreased body as a subject to be fired is a honeycomb degreased body having honeycomb shape. The honeycomb degreased body is fired to prepare a honeycomb fired body. A honeycomb structure body is manufactured by combining a plurality of the honeycomb fired bodies.

The following will describe the honeycomb structure and honeycomb fired body manufactured according to the embodiment of the present invention.

FIG. 6 is a perspective view schematically illustrating an example of the honeycomb structure manufactured according to the embodiment of the present invention.

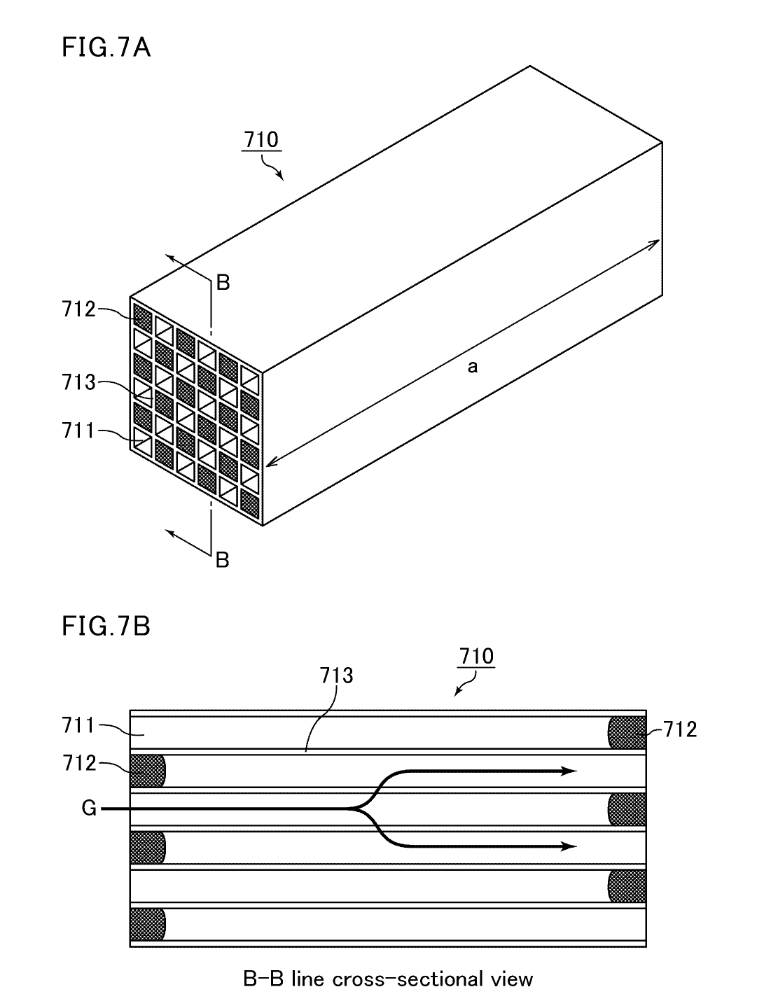

FIG. 7A is a perspective view schematically illustrating an example of the honeycomb fired body, and FIG. 7B is a B-B line cross-sectional view of FIG. 7A.

In a honeycomb structure 600 shown in FIG. 6, a plurality of honeycomb fired bodies 710 made of porous silicon carbide having a shape as shown in FIG. 7A and FIG. 7B are combined one another with a sealing material layer (adhesive layer) 601 interposed therebetween to form a ceramic block 603. Further, a sealing material layer (coat layer) 602 is formed on the periphery of the ceramic block 603.

As shown in FIG. 7A and FIG. 7B, in each of the honeycomb fired bodies 710, a large number of cells 711 are placed in parallel with one another in the longitudinal direction (in a direction indicated by an arrow “a” shown in FIG. 7A) with a cell wall 713 therebetween. Also, either end of the cells 711 is sealed with a plug material 712. Therefore, exhaust gas G which enters one of the cells 711 with one end sealed will always pass through the cell wall 713 dividing the cells 711 to flow out through another one of the cells 711 with an another end opened.

Accordingly, the cell wall 713 functions as a filter to capture PM or the like.

In the method of manufacturing a silicon-containing porous ceramic fired body of the present invention, the ceramic materials are not limited to ceramic powders such as silicon carbide and silicon nitride. A silicon-containing ceramic prepared by adding metal silicon to the ceramic, ceramic bonded by silicon, a silicate compound, or the like may be used as the ceramic materials.

Obviously, numerous modifications and variations of the present invention are possible in light of the above teachings. It is therefore to be understood that within the scope of the appended claims, the invention may be practiced otherwise than as specifically described herein.

1. A heater unit comprising:
a power source including a first power source terminal and a second power source terminal;
a plurality of heaters each connected to one another in series with respect to the power source, the plurality of heaters including a first heater and a second heater, the first heater being connected to the first power source terminal and having a first heater terminal and a second heater terminal, the second heater being connected to the second power source terminal and having a third heater terminal and a fourth heater terminal; and
a power supply position-switching device configured to switch between
a first state in which the first power source terminal is connected with the first heater terminal of the first heater, the second power source terminal is connected with the third heater terminal of the second heater, and the second heater terminal of the first heater is directly or indirectly connected with the fourth heater terminal of the second heater, and
a second state in which the first power source terminal is connected with the second heater terminal of the first heater, the second power source terminal is connected with the fourth heater terminal of the second heater, and the first heater terminal of the first heater is directly or indirectly connected with the third heater terminal of the second heater.

2. The heater unit according to claim 1,
wherein the plurality of heaters each include a plurality of resistance heating elements each connected to one another in parallel with respect to the power source.

3. The heater unit according to claim 1,
wherein each of the plurality of heaters is adjacent to one another.

4. The heater unit according to claim 2,
wherein the resistance heating elements are formed of carbon.

5. The heater unit according to claim 1, further comprising a transformer.

6. The heater unit according to claim 2,
wherein the plurality of resistance heating elements each have a substantially round-pillar shape or a substantially rectangular-pillar shape.

7. The heater unit according to claim 1,
wherein the first heater and the second heater are adjacent to one another.

8. The heater unit according to claim 1,
wherein the power supply position-switching device is configured to switch between the first state and the second state every about 168 operation hours to about 336 operation hours.

9. A firing furnace comprising:
a power source including a first power source terminal and a second power source terminal;
a casing;
a firing chamber disposed in the casing;
a plurality of heaters disposed in the casing and each connected to one another in series with respect to the power source, the plurality of heaters including a first heater and a second heater, the first heater being connected to the first power source terminal and having a first heater terminal and a second heater terminal, the second heater being connected to the second power source terminal and having a third heater terminal and a fourth heater terminal; and
a power supply position-switching device configured to switch between
a first state in which the first power source terminal is connected with the first heater terminal of the first heater, the second power source terminal is connected with the third heater terminal of the second heater, and the second heater terminal of the first heater is directly or indirectly connected with the fourth heater terminal of the second heater, and
a second state in which the first power source terminal is connected with the second heater terminal of the first heater, the second power source terminal is connected with the fourth heater terminal of the second heater, and the first heater terminal of the first heater is directly or indirectly connected with the third heater terminal of the second heater.

10. The firing furnace according to claim 9,
wherein the plurality of heaters each include a plurality of resistance heating elements each connected to one another in parallel with respect to the power source.

11. The firing furnace according to claim 9,
wherein each of the plurality of heaters is adjacent to one another.

12. The firing furnace according to claim 10,
wherein the resistance heating elements are formed of carbon.

13. The firing furnace according to claim 9, further comprising a transformer.

14. The firing furnace according to claim 9,
wherein the firing furnace is a continuous firing furnace which continuously fires a plurality of subjects to be fired while conveying the plurality of subjects.

15. The firing furnace according to claim 9,
wherein the plurality of heaters are disposed in a manner sandwiching a subject to be fired in the firing chamber.

16. The firing furnace according to claim 9,
wherein the plurality of heaters are disposed outside the firing chamber.

17. A method of manufacturing a silicon-containing porous ceramic fired body, comprising:
preparing a subject to be fired from a composition containing silicon-containing ceramic powders;
firing the subject using a firing furnace including:
a power source including a first power source terminal and a second power source terminal;
a casing;
a firing chamber disposed in the casing;
a power supply position-switching device; and
a plurality of heaters disposed in the casing and each connected to one another in series with respect to the power source, the plurality of heaters including a first heater and a second heater, the first heater being connected to the first power source terminal and having a first heater terminal and a second heater terminal, the second heater being connected to the second power source terminal and having a third heater terminal and a fourth heater terminal; and
switching a state of the furnace, using the power supply position-switching device, between
a first state in which the first power source terminal is connected with the first heater terminal of the first heater, the second power source terminal is connected with the third heater terminal of the second heater, and the second heater terminal of the first heater is directly or indirectly connected with the fourth heater terminal of the second heater, and
a second state in which the first power source terminal is connected with the second heater terminal of the first heater, the second power source terminal is connected with the fourth heater terminal of the second heater, and the first heater terminal of the first heater is directly or indirectly connected with the third heater terminal of the second heater.

18. The method according to claim 17,
wherein the plurality of heaters each include a plurality of resistance heating elements each connected to one another in parallel with respect to the power source.

19. The method according to claim 17,
wherein each of the plurality of heaters are adjacent to one another.

20. The method according to claim 18,
wherein the resistance heating elements are formed of carbon.

21. The method according to claim 17,
wherein the silicon-containing porous ceramic fired body includes porous silicon carbide or porous silicon nitride.

22. The method according to claim 17,
wherein the firing furnace is a continuous firing furnace which continuously fires a plurality of subjects while conveying the plurality of subjects.

23. The method according to claim 17,
wherein switching between the first state and the second state is performed every about 168 operation hours to about 336 operation hours.
